(19) United States
(12) Patent Application Publication
(10) Pub. No.: US 2014/0129392 A1
(43) Pub. Date: May 8, 2014

(54) GIFT SYSTEM

(71) Applicants: Shinichi HANAYAMA, Tokyo (JP); Hidemi MIYAO, Kanagawa (JP)

(72) Inventors: Shinichi HANAYAMA, Tokyo (JP); Hidemi MIYAO, Kanagawa (JP)

(21) Appl. No.: 14/152,745

(22) Filed: Jan. 10, 2014

Related U.S. Application Data
(63) Continuation of application No. PCT/JP2012/067705, filed on Jul. 11, 2012.

(30) Foreign Application Priority Data
Jul. 13, 2011 (JP) 2011-155051

(51) Int. Cl. G06Q 30/06

(52) U.S. Cl. CPC G06Q 30/0635
USPC 705/26.81

(57) ABSTRACT

A Web server device provides an order screen for ordering a product which an orderer gives to a participant to an information processing device of the orderer via the Internet, and transmits, upon receiving the order via the order screen, the order to a backyard terminal device in a backyard that provides the product, the backyard terminal device requests, upon receiving the order via the Web server device, an information output device to output information including a content of the order and identification information for identifying the participant to be given the product, the information output device outputs the information upon receiving the request, and the Web server device notifies, upon confirming reception of the product by the participant, the information processing device of the orderer who ordered the product of the reception via the Internet.

### TECHNICAL FIELD

The present invention relates to a gift system.

### BACKGROUND ART

There are known streaming distribution and microblogs such as Twitter and so on via the Internet.

### CITATION LIST

### Patent Literature

Patent Literature 1: Japanese Laid-open Patent Publication No. 2006-81895

### SUMMARY OF INVENTION

### Technical Problem

In conventional systems, however, an operator of a PC or the like can only view a moving image of an event carried out at a venue over the Internet or view a list of tweets of participants participating in the event on a TL (time line) of Twitter but cannot give or donate drink or food to a specific person in the venue.

The present invention has been made in consideration of the problem and its object is to provide a technique of making it possible to give or donate an arbitrary product such as drink, food or the like or service to a specific person over the Internet.

### Solution to Problem

Hence, the present invention is a gift system including a Web server device, a backyard terminal device in a backyard that provides a product which an orderer gives to a participant, and an information output device, wherein the Web server device provides an order screen for ordering the product which the orderer gives to the participant to an information processing device of the orderer via the Internet, and transmits, upon receiving the order via the order screen, the order to the backyard terminal device in the backyard that provides the product, wherein the backyard terminal device requests, upon receiving the order via the Web server device, the information output device to output information including a content of the order and identification information for identifying the participant to be given the product, wherein the information output device outputs the information upon receiving the request, and wherein the Web server device notifies, upon confirming reception of the product by the participant, the information processing device of the orderer who ordered the product of the reception via the Internet.

Note that the information processing device of the orderer is a later-described PC, mobile phone, smart phone or the like of the orderer.

### Advantageous Effects of Invention

According to the present invention, a technique can be provided which makes it possible to give or donate an arbitrary product such as drink, food or the like or service to a specific person over the Internet.

### BRIEF DESCRIPTION OF DRAWINGS

FIG. 1 is a diagram illustrating an example of a system configuration and the like of a product gift system.

FIG. 2 is a diagram illustrating an example of the flow of information and articles in an event venue.

FIG. 3 is a diagram illustrating an example of a software configuration and the like of “Ogorare-kun.”

FIG. 4 is a view illustrating an example of an invoice receipt.

FIG. 5 is a view illustrating an example of a screen image of a reception signature.

FIG. 6 is a view illustrating an example of a duplicate receipt for store.

FIG. 7 is a flowchart illustrating an example of entrance processing.

FIG. 8 is a flowchart illustrating an example of exit processing.

FIG. 9 is a flowchart illustrating an example of reception signature processing.

FIG. 10 is a flowchart illustrating an example of authentication processing for smart phone.

FIG. 11 is a view illustrating an example of an authentication error screen.

FIG. 12 is a view for explaining processing of participation registration, deregistration, and reception signature utilizing access codes when there is no QR code reader.

FIG. 13 is a view illustrating an example of an event top page displayed on a PC or the like of the orderer.

FIG. 14 is a view illustrating an example of an event top page displayed on the PC or the like of the orderer.

FIG. 15 is a view illustrating an example of an order making screen.

FIG. 16 is a view illustrating an example of an order list screen.

FIG. 17 is a view illustrating an example of a confirmation screen for order.

FIG. 18 is a view illustrating an example of a completion screen.

FIG. 19 is a view illustrating an example of an event top page displayed on the PC or the like of the orderer.

FIG. 20 is a view illustrating an example of a ranking screen.

FIG. 21 is a view for explaining a measure against mischief.

FIG. 22 is a view for explaining tracking of the location of a participant and valid/invalid control using positional information.

FIG. 23 is a view for explaining a trigger function using reservation and the positional information.

FIG. 24 is a view illustrating an example in which a “give distributor” button is prepared beside a distribution screen.

### DESCRIPTION OF EMBODIMENTS

Hereinafter, embodiments of the present invention will be described with reference to the drawings.

### First Embodiment

### (System Configuration)

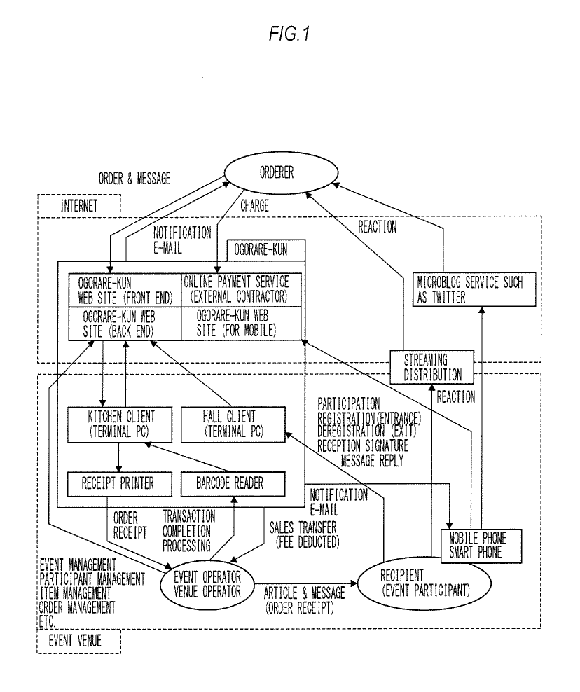

FIG. 1 is a diagram illustrating an example of a system configuration and the like of a product gift system. Note that in this specification, the product gift system is also referred to simply as “Ogorare-kun.”

Here, the “Ogorare-kun” is a system to be used together with Internet streaming distribution, microblog services such as Twitter and the like, and various systems such as various message boards, SNS, blog, chatting, e-mail and so on. An orderer can give a specific person in a venue drink or food over the Internet on a WEB site of the “Ogorare-kun” using a PC, mobile phone, smart phone or the like. Note that the “Ogorare-kun” is provided on the assumption that drink and food are on sale in the venue or within a distance from which the drink and food can be directly delivered to the venue.

Once the orderer selects an item and a participant on the WEB site and places an order, the order is instantaneously (automatically) sent to a kitchen, and store staff thus process the order similarly to a normal order, and an article is delivered to the designated participant (visitor). The series of processes are executed substantially in real time. The orderer can obtain reaction from a recipient of a product through the streaming distribution, Twitter or the like in about several tens of minutes to about one hour (time period required for the store staff prepare drink/food and deliver it to the recipient) after placing the order.

When placing the order, the orderer can attach his/her nickname (anonymity acceptable), optional short message, photograph, image, sound, video and the like to the order. The message is passed to the recipient together with the article. Utilizing the content of the item and the message together can further warm up the event. Further, reading aloud the message by a master of ceremony, store staff or the like is more effective.

The orderer performs real-time settlement of a charge through an online payment service. Once the article is delivered to the recipient (once received by the recipient), a notification e-mail is sent to the orderer from the “Ogorare-kun.” It is also possible to make setting such that if the article is not delivered to the recipient because of absence of the recipient or the like, the order is cancelled and all of the charge is returned to the orderer (similarly, a notification e-mail is sent to the orderer from the “Ogorare-kun”). Note that the server device may send not the notification e-mail but the notification together with the notification e-mail to the account of the microblog service such as Twitter or the like of the orderer who ordered the product. This case is on the assumption that the server device approves and cooperates with the microblog service such as Twitter or the like.

The recipient can input a reply message when receiving, and the message is attached to the aforementioned notification e-mail to the orderer.

An object person that will be the recipient is a person who has come to the event venue and registered participation in the “Ogorare-kun” (and not deregistered it). The participation registration is performed by a method of pre-registration, a method of registration on site by using a mobile gadget such as a mobile phone, smart phone or the like, a method of registration by a terminal installed at the venue or the like. The “Ogorare-kun” can manage entering and exiting the venue to prevent an order for a person absent from the venue from being placed. This prevents an order for a person other than the object person from being placed on the WEB site.

Further, it is possible to prohibit an order of a specific item for a specific person in the “Ogorare-kun” so as to prevent an order of alcoholic liquors for a participant who cannot drink alcohol such as a minor, a person who needs to drive or the like, from being placed. This can be set depending on the intention of the participant and the intention of the operator. It is also possible to set the upper limit of the money amount of products or the number of products which are given to one participant in the “Ogorare-kun” so as to prevent orders from being concentrated in a short time or on one person.

Note that the case where the “Ogorare-kun” is introduced into the event venue (event hall) will be described as an example unless otherwise stated in the embodiment described below. However, the “Ogorare-kun” may be introduced into a club with live music, nightclub and the like. The “Ogorare-kun” may also be introduced into any place (store) where moving image can be relayed, such as Japanese style pub and restaurant, leisure facilities such as Net cafe, karaoke box, entertainment center (game arcade, Japanese pinball arcade), and theme park, cabaret-like club, fortune-telling booth.

Further, the example illustrated in FIG. 1 is an example where the “Ogorare-kun” is introduced together with the streaming distribution and microblog services such as Twitter using an Internet camera or the like, but the “Ogorare-kun” may be introduced together with only any one of them.

Note that the “Ogorare-kun” will be described assuming that an Ogorare-kun WEB site (front end), an Ogorare-kun WEB site (back end), an online payment service, and an Ogorare-kun WEB site (for mobile) are installed in one server device (computer) in this specification. Incidentally, this is not for limiting the embodiment, but they may be individually installed in separate server devices.

A CPU of the server device executes a program stored in a memory of the server device and thereby implements the aforementioned functions. As for a kitchen client (terminal PC), a hall client (terminal PC), a receipt printer, a barcode reader and so on, respective CPUs of the devices similarly execute programs stored in respective memories of the devices and thereby implement respective functions of the devices. This also applies to the PC of the orderer and the mobile phone or smart phone of the recipient (event participant). The kitchen client (terminal PC) is one example of a backyard terminal device. A kitchen is one example of the backyard that provides products. The hall client (terminal PC) is one example of a terminal device that the participant can operate. The receipt printer is one example of an information output device. Note that information including a content of an order and identification information for identifying a participant to be given a product will be described as being outputted on a receipt in this embodiment but is not limited to this configuration. The information may be displayed on a display device such as a display. In this case, the information output device is, for example, the display or the like.

(Flow of Information and Articles in the Event Venue)

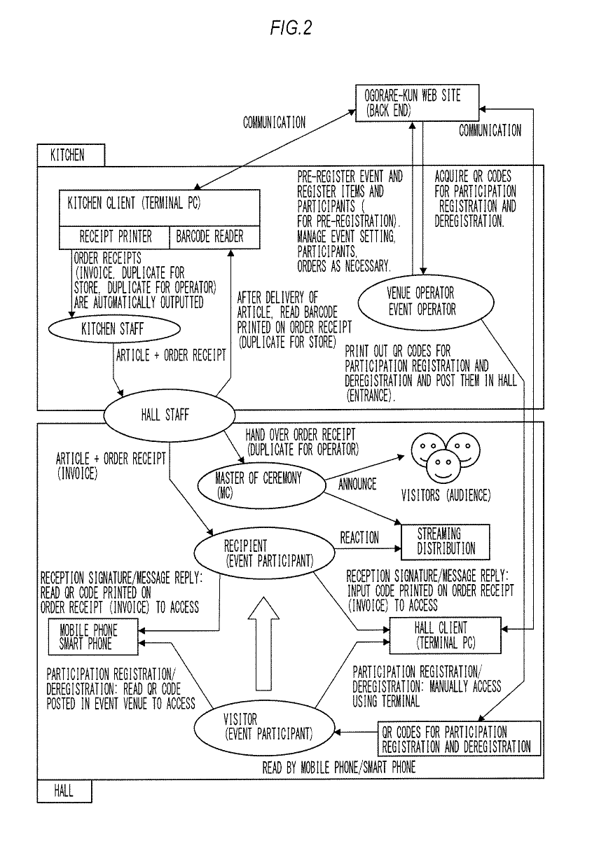

FIG. 2 is a diagram illustrating an example of the flow of information and articles in the event venue.

A general configuration is illustrated and the flow is not limited to this configuration, depending on the organization of the venue operation and event operation.

The server device that is one example of a Web server device provides an order screen for ordering a product which an orderer gives to a participant in the event to the PC or the like of the orderer, and upon receiving the order through the order screen, transmits the order to the kitchen client (terminal PC) that is one example of the kitchen terminal device.

Upon receiving the order via the server device, the kitchen client (terminal PC) requests the receipt printer that is one example of the information output device to output a receipt including the content of the order and the identification information for identifying the participant to be given the product and a code for reception confirmation of the product.

Upon receiving the request, the receipt printer outputs the receipt. The participant in the event that is the recipient who has received the product together with the receipt reads the receipt on which a QR code (registered trademark) that is one example of code is provided by using a mobile phone, a smart phone or the like that is one example of the mobile terminal device to access, for example, a predetermined URL or the like of the server device. Note that the QR code that is one example of code will be described as an example of the code in this embodiment, but this does not limit this embodiment.

When accessed from the mobile phone or smart phone of the participant who has been given the product by reading the QR code on the receipt, the server device confirms reception of the product and then sends a notification e-mail to the PC or the like of the orderer.

### (Software Configuration)

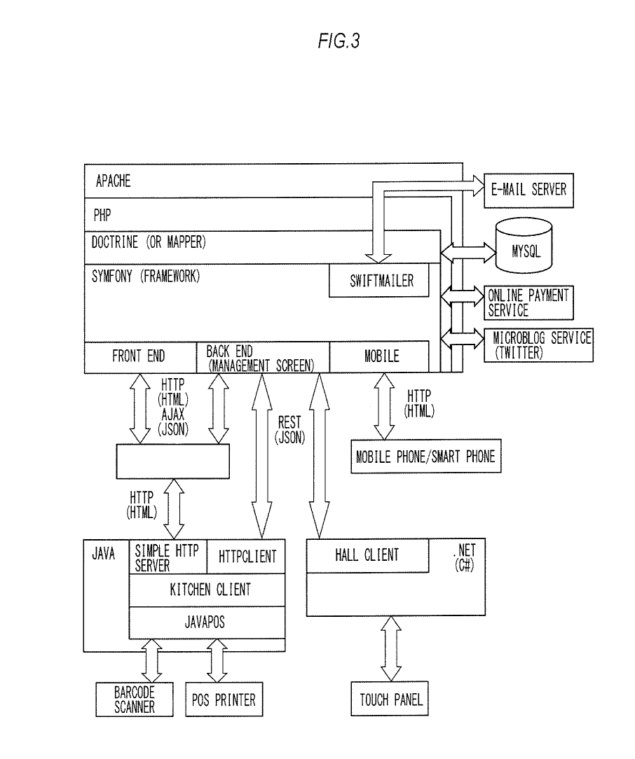

FIG. 3 is a diagram illustrating an example of the software configuration and the like of the “Ogorare-kun.”

Here, there are three kinds of order receipts to be outputted from the receipt printer, which are an invoice, a duplicate for store, a duplicate for operator. The three kinds of order receipts are outputted in one set for one transaction.

Note that, in this embodiment, the orderer is a person on the side of giving a product. The participant is a person on the side of being given a product. As for the transaction, a single payment of a charge by the orderer through the online payment service is defined as one transaction. The transaction includes a plurality of orders. As for the order, one kind of item, a plurality of participants, the number of items for each of the participants (* the number of items is settable for each participant) which are selected by the orderer, information on the orderer (nickname, e-mail address and so on), and a message, as a set, are defined as an order. The order includes one kind of item, a plurality of participants, and the number of items for each of the participants, one piece of orderer information, and a message.

(Invoice Receipt)

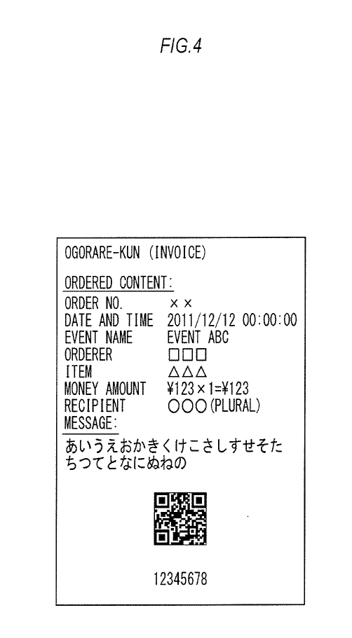

FIG. 4 is a view illustrating an example of an invoice receipt. The invoice receipt is a receipt that is handed over to the recipient together with the article. Invoice receipts corresponding to the number of orders included in the transaction are outputted. The invoice receipt includes the following contents.
order No.
date and time
event name
orderer name
item name
money amount (unit price*quantity=total)
recipient name and quantity (plural)
message
reception signature/mobile access QR code
reception signature/terminal access code

(Screen Image of Reception Signature)

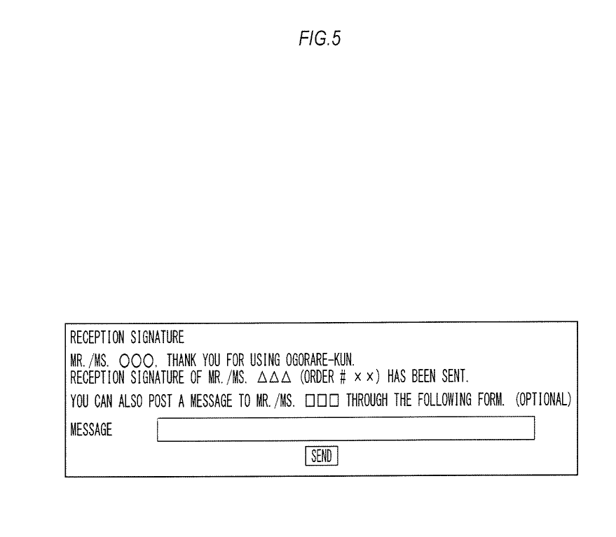

FIG. 5 is a view illustrating an example of a screen image of a reception signature.

Upon receiving the article, the recipient essentially reads an “access QR code for reception signature” printed on the receipt by the mobile phone or smart phone on hand to access an Ogorare-kun mobile site and thereby put his/her signature. Note that a person who cannot access the site by the mobile phone or smart phone can also put his/her signature on the hall client (terminal PC). When there are a plurality of recipients, only one of them needs to put his/her signature as a representative.

The recipient can send a message to the orderer together with his/her signature.

Once the recipient inputs the message on the screen illustrated in FIG. 5 when putting his/her signature and then presses a send button, the server device automatically sends a notification e-mail to the appropriate orderer.

(Duplicate Receipt for Store)

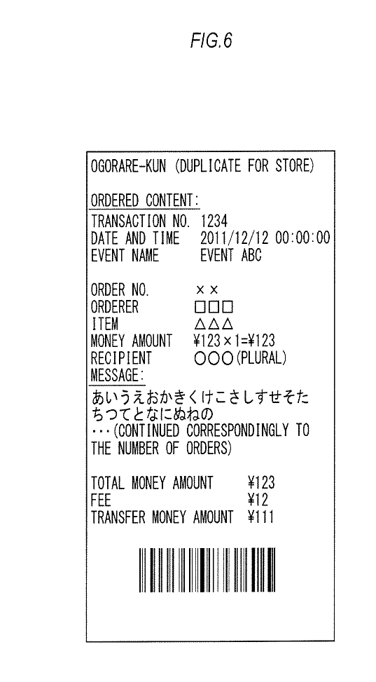

FIG. 6 is a view illustrating an example of a duplicate receipt for store.

The duplicate receipt for store is a receipt issued on the basis of one for each transaction and has all order information included in the transaction written thereon, which is kept by the venue operator. The duplicate receipt for store includes the following contents.
transaction No.
date and time
event name
total money amount
fee
transfer money amount (money amount to be paid to venue operator)
barcode (transaction No.)

The followings are outputted correspondingly to the number of orders included in the transaction.
order No.
orderer name
item name
money amount (unit price*quantity=total)
recipient name and quantity (plural)
message

After delivering the article to the recipient, the venue operator (hall staff) reads the barcode by a barcode scanner to notify the Ogorare-kun WEB site that the transaction has been completed, through the kitchen client (terminal PC). In the case where the recipient has already put his/her signature, the order is fixed as sales of the venue operator.

(Duplicate Receipt for Operator)

The duplicate receipt for operator is a receipt arbitrarily utilized by the event operator. As for its standard usage, the duplicate receipt for operator is handed over to the master of ceremony (MC) and announced in the venue or on the streaming distribution. The contents of the duplicate receipt for operator are the same as those of the duplicate receipt for store. Any number of duplicate receipts for operator can be outputted through setting of the kitchen client (terminal PC).

(Entrance and Exit Management and Reception Signature by QR Codes and Mobile Terminal Device)

To manage entrance and exit of a participant to/from the event venue and to send the article reception signature to the Ogorare-kun WEB site, a “QR code” and the mobile phone (with a QR code reader function) or smart phone owned by the participant are used. Almost all of models of mobile phones and smart phones are equipped with a digital camera. Almost all of mobile phones are also equipped with a QR code reader as standard, and smart phones can also read the QR code if its application is installed therein.

To the mobile phone, a unique ID (individual identification number) is allocated to each terminal, and the server device can acquire the individual identification number of the mobile phone accessing it through the WEB site for mobile. Accordingly, it is possible to reduce the labor of inputting the individual ID as much as possible so as to easily perform a participation registration or deregistration operation.

Note that the server device cannot acquire the individual identification number from a smart phone. Accordingly, in the case of the smart phone, advance user registration and log-in are required.

(Entrance Flow)

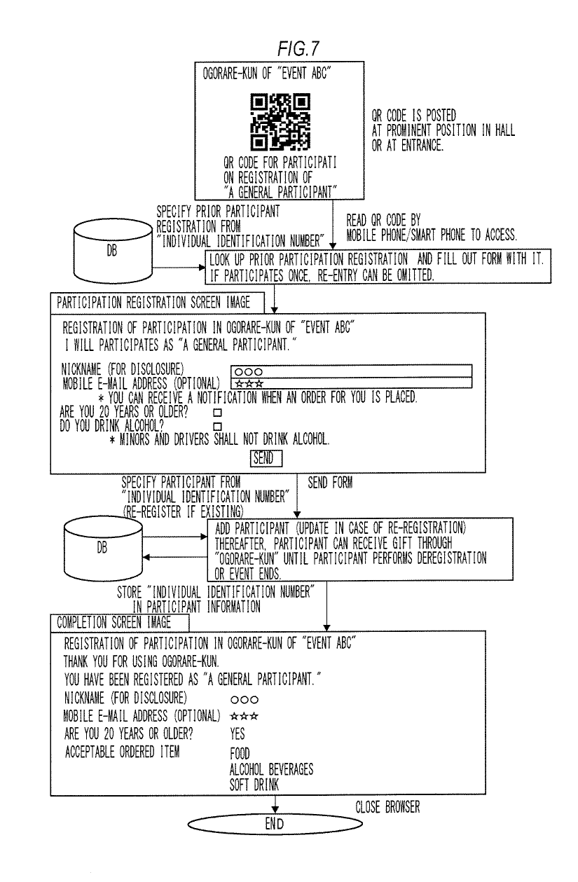

FIG. 7 is a flowchart illustrating an example of entrance processing.

A prospective participant reads a QR code for participation registration posted at a prominent position in the hall or at the entrance by using a mobile phone or smart phone to access the server device.

When accessed via the QR code for participation registration, the server device specifies prior participant registration, if existing, from a DB stored in the memory or the like of the own device, on the basis of the individual identification number.

If information on the prior participant registration exists, the server device fills out (inputs and fill) a form with the information. In other words, once participates, the prospective participant can omit re-entry.

The server device causes a browser of the mobile phone or smart phone to display a screen illustrated in a participation registration screen image in FIG. 7 (a screen where prior information is filled when the prior information exists, or a screen where no information is filled when no prior information exists). Once the prospective participant inputs on the screen and presses a send button, the form is sent, and the server device adds participant information on the participant in association with the individual identification number to the DB, or updates the participant information in the case of re-registration, on the basis of the individual identification number. Thereafter, the participant can receive a gift through the “Ogorare-kun” until the participant performs deregistration or the event ends.

After performing registration or updating of the participant information, the server device causes the browser of the mobile phone or smart phone to display a screen as illustrated in a completion screen image in FIG. 7.

(Exit Flow)

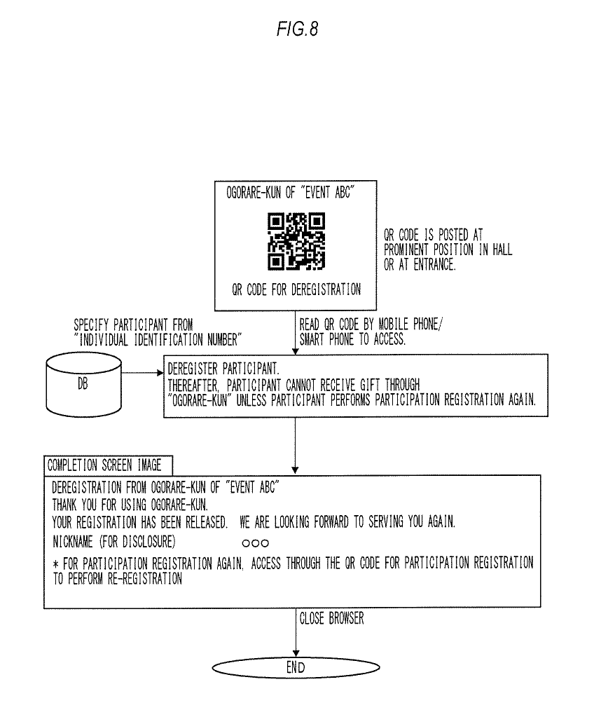

FIG. 8 is a flowchart illustrating an example of exit processing.

A participant reads a QR code for deregistration (participation deregistration) posted at a prominent position in the hall or at the entrance by using a mobile phone or smart phone to access the server device.

When accessed via the QR code for deregistration, the server device specifies the participant from the individual identification number, and performs deregistration, for example, by setting information indicating deregistration in the participant information or the like. Thereafter, the participant cannot receive a gift through the “Ogorare-kun” unless the participant performs participation registration again.

After performing the participation deregistration of the participant, the server device causes the browser of the mobile phone or smart phone to display a screen as illustrated in a completion screen image in FIG. 8.

The participant only needs to access the QR code without inputting anything for the participation deregistration.

(Reception Signature)

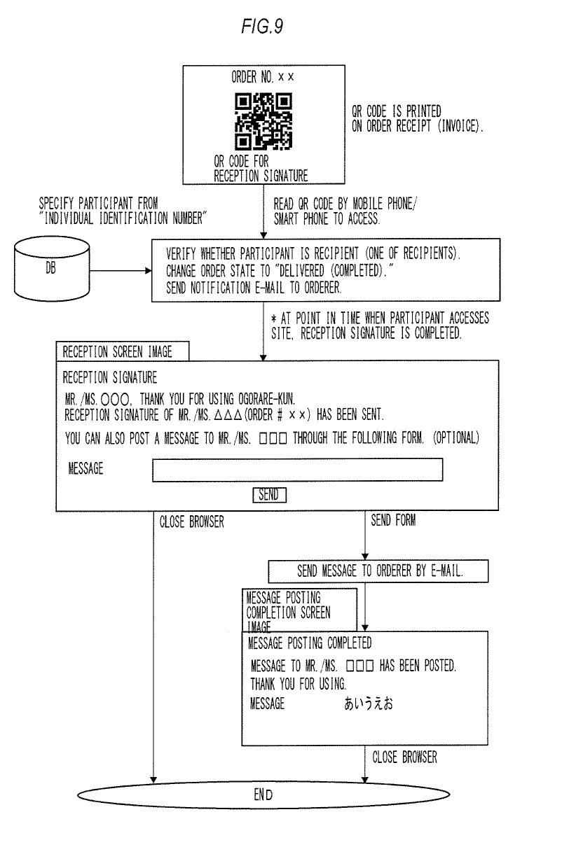

FIG. 9 is a flowchart illustrating an example of reception signature processing.

A participant reads a QR code for reception signature printed on the order receipt by using a mobile phone or smart phone to access the server device.

When accessed via the QR code for reception signature, the server device specifies the participant from the individual identification number and verifies whether the participant is the recipient (one of the recipients). When the participant is the recipient (one of the recipients), the server device changes the state of the order to “delivered (completed)” and sends a notification e-mail to the orderer. Note that at the point in time when the participant reads the QR code for reception signature to access the server device, the reception signature is completed.

Further, the server device causes the browser of the mobile phone or smart phone of the participant to display a screen as illustrated in a reception signature screen image in FIG. 9. When the participant closes the screen, the server device ends the processing illustrated in FIG. 9. On the other hand, when the participant inputs a message and presses a send button, the server device sends the message to the orderer by e-mail and causes the browser of the mobile phone or smart phone of the participant to display a screen as illustrated in a message posting completion screen image in FIG. 9. Then, when the participant closes the screen, the server device ends the processing illustrated in FIG. 9.

(Response to Smart Phone)

Since the server device cannot acquire the individual identification number from a smart phone as described above, user registration and authentication are required. In this system, a process of sending a blank e-mail is utilized for the authentication.

Once the authentication is made, a unique registration code is registered in a browser cookie, so that the above-described authentication process is unnecessary from the next time unless the cookie is cleared in the browser. When the QR code reader is available, the same flow as in the mobile phone applies to the smart phone thereafter.

Note that it is based on the premise that the cookie is enabled in the setting of the browser.

Further, a top page URL and access code (random alphanumeric characters in several digits) may be printed together with the QR code. This makes it possible that a prospective participant accesses the top page for smart phone and inputs the access code to thereby make the same state as that by accessing via the QR code.

(Authentication Flow for Smart Phone)

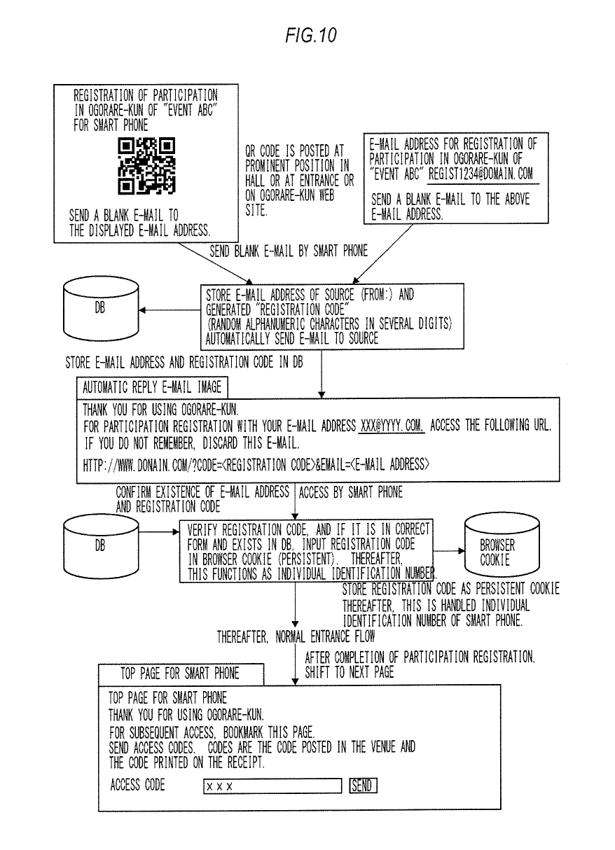

FIG. 10 is a flowchart illustrating an example of authentication processing for smart phone.

A QR code and an e-mail address illustrated in FIG. 10 are posted at a prominent position in the hall or at the entrance or on the WEB site. A prospective participant reads the QR code or directly types out the e-mail address to send a blank e-mail.

Upon receiving the blank e-mail, the server device stores an e-mail address of source and a generated registration code (random alphanumeric characters in several digits) and automatically sends to the source an e-mail as illustrated in an automatic reply e-mail image in FIG. 10. When accessed from the smart phone via the URL written in the e-mail, the server device holds the registration code in the browser cookie if the registration code filled in the URL is in the correct form and exists in the DB. Thereafter, this registration code is handled as the individual identification number of the smart phone. Thereafter, the entrance processing is performed by the same processing as the above-described processing illustrated in FIG. 7.

(Processing when Having Failed to Recognize Individual Identification Number in Cookie)

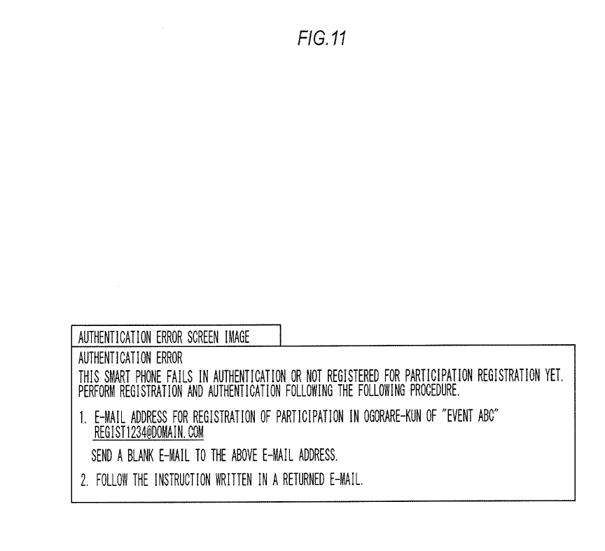

Note that when having failed to recognize the individual identification number in the browser cookie, the server device causes the browser of the smart phone to display a screen as illustrated in an authentication error screen image in FIG. 11 to promote registration. FIG. 11 is a view illustrating an example of an authentication error screen.

(Processing of Participation Registration, Deregistration, Reception Signature Utilizing Access Codes)

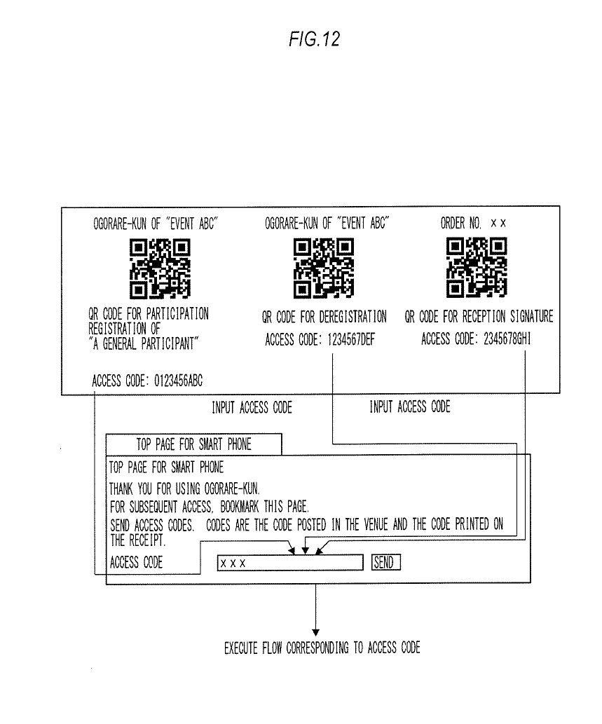

FIG. 12 is a view for explaining processing of participation registration, deregistration, and reception signature utilizing access codes when there is no QR code reader. As illustrated in FIG. 12, even a user of a smart phone with no QR code reader can participate in the event, perform deregistration, and put his/her reception signature as illustrated in FIG. 12.

(Order Making)

Hereinafter, screen shift and so on when the orderer makes an order and pays a charge will be described.

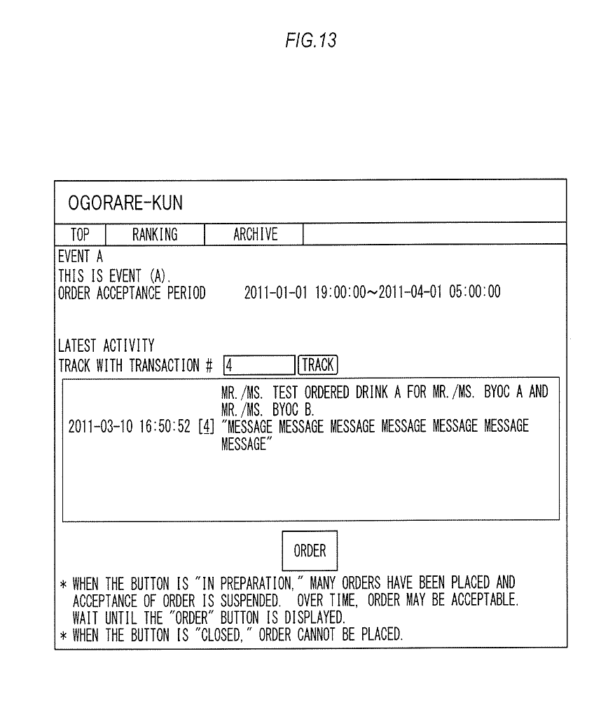

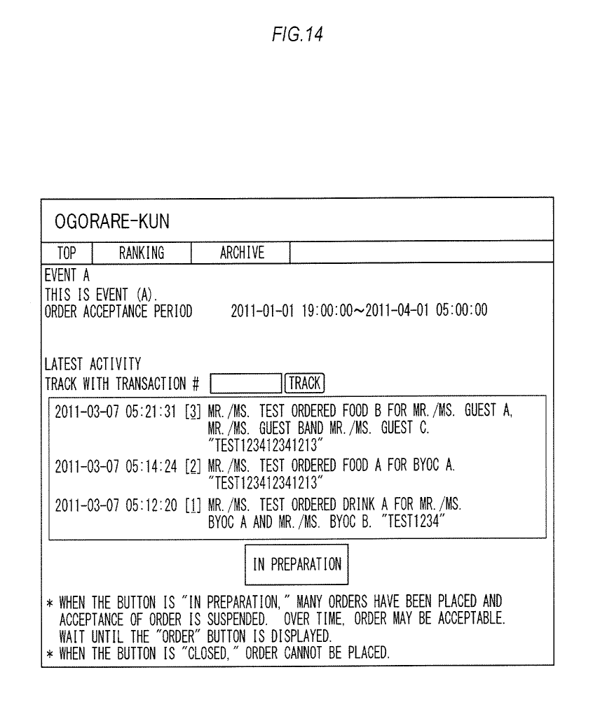

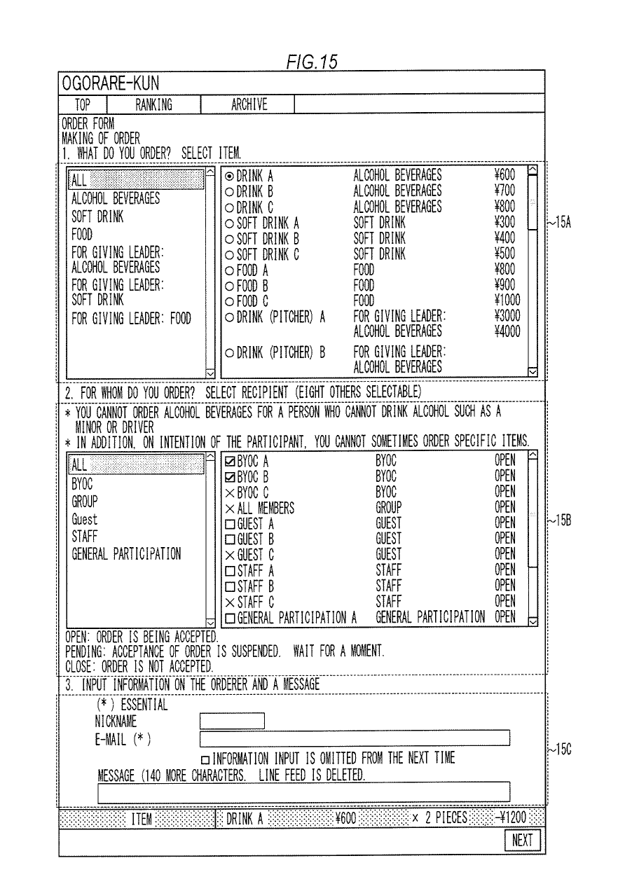

FIG. 13 and FIG. 14 are views illustrating examples of an event top page displayed on the PC or the like of the orderer. The orderer can request to make an order in the appropriate event by pressing an order button of the event top page in FIG. 13. When the order button is pressed, the screen is shifted to a screen illustrated in FIG. 15. Note that the server device may be configured such that when a limit is provided in number of orders or total money amount by the setting, the order button cannot be pressed any longer because it reaches a limit value as illustrated in FIG. 14.

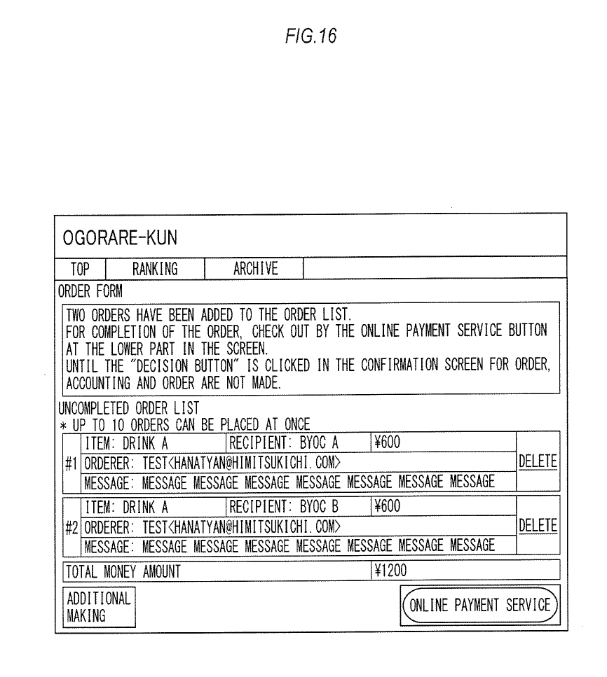

FIG. 15 is a view illustrating an example of an order making screen. In the screen, at a part illustrated with 15A, the orderer selects items. Only one item can be selected for one order. Further, the orderer selects a recipient at a part illustrated with 15B. A plurality of recipients can be selected for one order. Further, the orderer can select the quantity for each recipient. Further, the orderer inputs information on the orderer and a message at a part illustrated with 15C. A nickname may be optionally inputted or can also be anonymized. However, an e-mail address needs to be inputted for receiving a notification afterward. When a next button is pressed, the server device makes an order according to the inputted content and the screen shifts to a screen illustrated in FIG. 16.

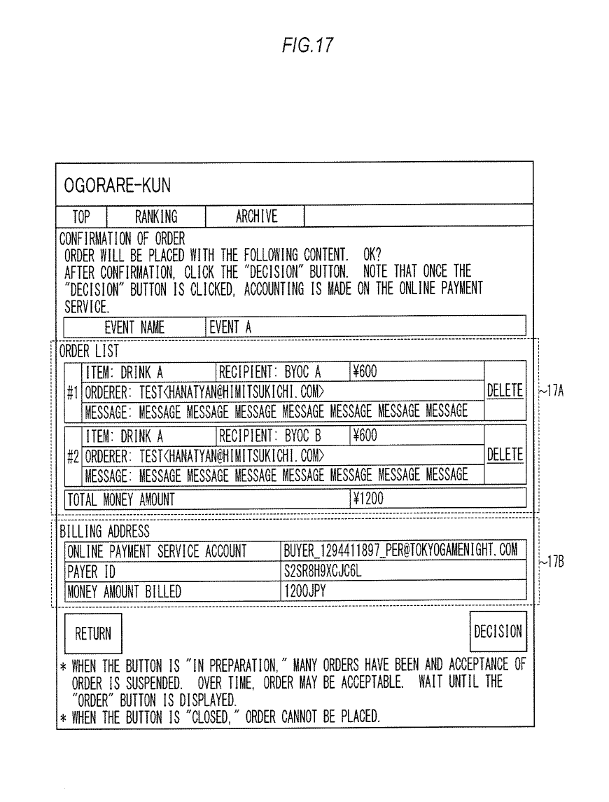

FIG. 16 is a view illustrating an example of an order list screen. In the screen illustrated in FIG. 16, the orderer can confirm the list of orders made and the total money amount. Further, the orderer can delete unnecessary orders with a delete button. Note that after the confirmation of orders, the orderer presses a button of the online payment service to make a payment online. After completion of the payment online, the screen shifts to a screen illustrated in FIG. 17.

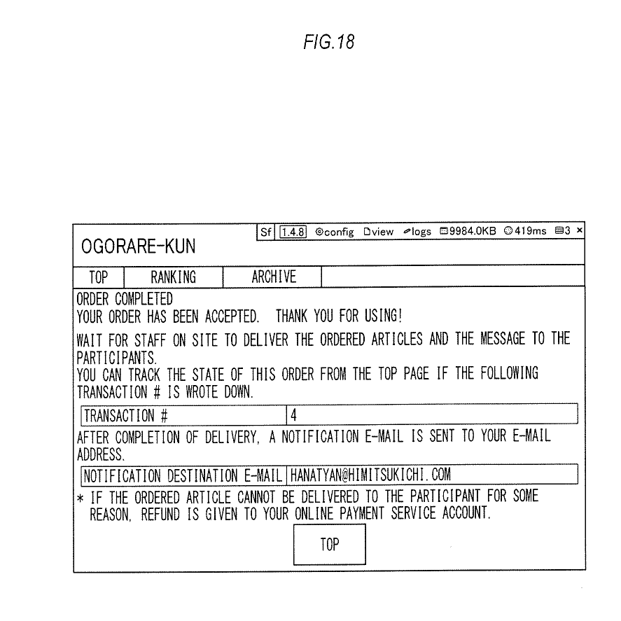

FIG. 17 is a view illustrating an example of a confirmation screen for order. The orderer can confirm the list of orders made and the total money amount of a charge at a part illustrated with 17A. Further, a settlement method and contents can be confirmed at a part illustrated with 17B. When a decision button is pressed, the server device decides the settlement through the online payment service and the screen shifts to a screen illustrated in FIG. 18. Note that the server device may be configured such that when a limit is provided in number of orders as a whole or total money amount by the setting, the decision button cannot be pressed any longer because it reaches a limit value.

FIG. 18 is a view illustrating an example of a completion screen. The orderer can confirm a transaction No. and an e-mail address for receiving a notification in the completion screen.

Here, every time an event that the orderer places an order, that an ordered article is delivered to a recipient, or that the order is cancelled occurs, the server device registers the log of the event in an order activity.

In each order activity, a transaction No. is filled so that the orderer can track the state of his/her own transaction afterward. The event to be recorded as the order activity and information displayed in each event are as follows.
Order has been placed
date and time
transaction No.
item name
recipient name and quantity (plural)
nickname and message inputted by the orderer when making the order
Ordered article has been delivered to the recipient
date and time
transaction No.
item name
recipient name and quantity (plural)
message inputted by the recipient when putting his/her signature (if applicable)
Order has been cancelled
date and time
transaction No.
item name
recipient name and quantity (plural)
message inputted by the venue operator when cancelling (if applicable)
Reply message from the recipient has been posted
date and time
transaction No.
recipient name
orderer name
message

Note that the order activity is displayed on the top page of the event and automatically updated every fixed time by the server device. Basically, all of activities are disclosed, so that anyone even other than the orderer can browse them.

Further, the server device may be configured to display a warning or the like when the message inputted by the orderer or the recipient includes a preset NG word.

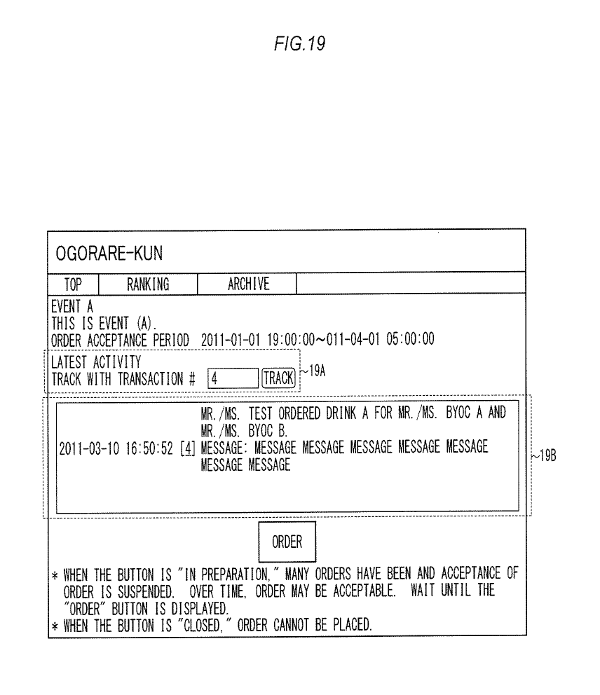

FIG. 19 is a view illustrating an example of an event top page displayed on the PC or the like of the orderer. By inputting a transaction No. in a part illustrated with 19A and pressing a track button, the orderer can track the state of the corresponding transaction. Further, the orderer can confirm the latest order activity at a part illustrated with 19B.

(Ranking)

The server device takes statistics how many times and who were given, and displays their ranking.

Further, the server device allocates the following parameters to items, and displays what each participant tends to be given.

The ranked parameters are as follows.

Amount: Total money amount given.

Count: Number of times given.

Fat: Foodstuff. Mainly increases when food is given.

Drunk: Amount of alcohol. Mainly increases when alcohol beverages are given.

Moist: Moisture. Mainly increases when a beverage is given.

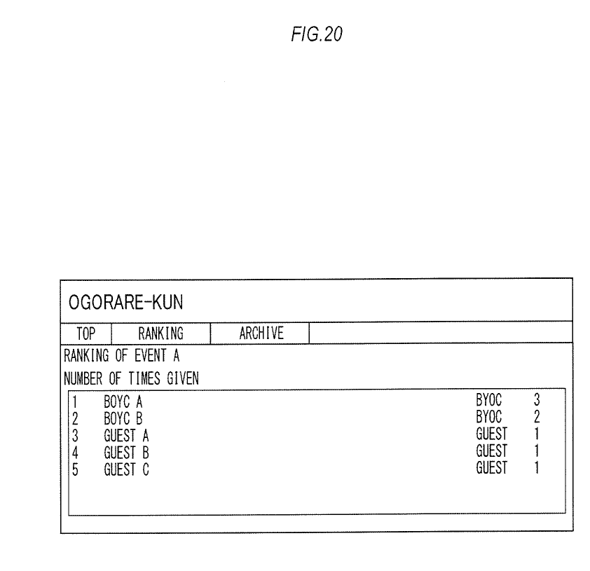

FIG. 20 is a view illustrating an example of a ranking screen.

In FIG. 20, as an example, the ranking of the number of times given is displayed. Anyone can browse the ranking from the Ogorare-kun WEB site.

Note that the server device may be configured to change avatars of participants according to the parameters. For example, the server device may change the avatar in such a manner that the avatar grows fat with an increase in Fat, the avatar gets drunk with an increase in Drunk, the avatar gets dry with shortage of Moist, and so on.

Further, when a parameter more than a fixed value is achieved, the server device may give a title to the participant (or the orderer) and display the title on the ranking screen or the like. For example, when the number of times of a participant (or orderer) who has been given (or who has given) exceeds 100, the server device may give a title of a “given leader,” a “giving leader” or the like for ranking display.

(Event Management)

For example, the event operator can perform registration, setting change, deletion, list display, and output of various QR codes of the event via the server device.

Settable items and so on are listed below.

Event name: Title of this event.

Explanation: Sentences displayed on the top page of the event. HTML is available.

Start date and time: Date and time when this event is started (acceptance of order is started)

End date and time: Date and time when this event is ended (acceptance of order is ended)

Minimum interval (sec): How many seconds acceptance of a new transaction is suspended after one transaction occurs in this event is set.

Maximum total money amount (whole): Total money amount for all transactions acceptable in this event.

Maximum number of cases (whole): Total number of cases for all transactions acceptable in this event.

Maximum total money amount (each orderer): Total money amount for each orderer of transactions acceptable in this event.

Maximum number of cases (each orderer): Total number of cases for each orderer of transactions acceptable in this event.

Unit period (sec): Number of seconds defined as a unit. Used for the following limit setting.

Maximum total money amount per unit period (whole): Total money amount for all transactions acceptable in the unit period.

Maximum number of cases per unit period (whole): Total number of cases for all transactions acceptable in the unit period.

Maximum total money amount per unit period (each participant): Total money amount for each participant of transactions acceptable in the unit period.

Maximum number of cases per unit period (each participant): Total number of cases for each participant of transactions acceptable in the unit period.

Maximum number of orders per transaction: Maximum, number of orders which can be included in one transaction.

Valid flag: Flag which can control validity of this event. When it is invalid, acceptance of a new transaction is suspended.

Nameless permission: Whether to permit an anonymous order. Control whether an input box for nickname is essential or optional in the order making form is possible.

Cancel policy: Policy about handling of cancel, whether to place a guard at the contracted store side or at the orderer side. The orderer is notified of the policy in an order confirmation screen.

An illustrative sentence can be called by selecting either of the following two patterns.
Placing a guard at the contracted store side When the recipient is absent from the venue, handling of the order is left to the contracted store (to give another participant or the like).
Placing a guard at the orderer side

When the recipient is absent from the venue, the order is necessarily cancelled.

(Item Management)

Further, for example, the event operator can perform registration, setting change, deletion, and list display of items via the server device.

Settable items and so on are listed below.

Item name: Name of an item.

Price (including tax): Price of an item (including consumption tax)

Item classification: Belonging item classification.

Explanation: Sentence about details of item. It is assumed to be displayed on the front end.

Valid flag: Flag which can control validity of this item. If it is invalid, order cannot be placed. Flag for prohibiting an order from being placed without deleting it.

(Participant Management)

Further, for example, the event operator can perform registration, setting change, deletion, and list display of participants (recipients) via the server device.

Settable items and so on are listed below.

Event: Event in which this participant participates.

Name: Name (nickname) of the participant.

E-mail: E-mail address to which a notification is sent.

Participant classification: Belonging participant classification.

Explanation: Sentence about details of the participant. It is assumed to be displayed on the front end.

Adult flag: Flag indicating whether the participant is an adult (20 years or older). Unless an adult, an item in the item classification of “adult only” cannot be ordered.

Valid flag: Flag which can control validity of this participant. If it is invalid, order cannot be placed.

Order impossible item classification: A plurality of item classifications which cannot be ordered for this participant can be selected.

(Order Management)

Further, for example, the event operator can perform list display and state change of orders via the server device.

Correctable items and so on are listed below.

Message: Message inputted by an orderer.

Reply message: Message replied from a recipient.

State: State of an order (unprocessed, placed an order with a store, cancelled, completed)

(Transaction Management)

Further, for example, the event operator can perform list display and state change of transactions via the server device.

Correctable items and so on are listed below.

State: State of a transaction (unprocessed, under processing at a store, cancelled, completed)

(Activity Management)

Further, for example, the event operator can perform rewriting, deletion, and list display of order activities via the server device.

Correctable items and so on are listed below.

Status: Content of an activity.

(Item Classification Management)

Further, for example, the event operator can perform registration, setting change, deletion, and list display of item classifications (food, alcohol beverages, soft drink and so on) via the server device.

The management of item classifications can make it possible to prohibit a specific classification from being ordered for a minor, or limit a specific participant classification and an item classification which can be ordered for a specific participant.

Settable items and so on are listed below.

Item classification name: Name of this item classification.

Adult-only flag: Flag which controls whether this item classification can be ordered only for an adult participant.

(Participant Classification Management)

Further, for example, the event operator can perform registration, setting change, deletion, and list display of participant classifications (staff, guest, general participant and so on) via the server device.

The management of participant classifications can make it possible to set item classifications which can be ordered, for each participant classification.

Settable items and so on are listed below.

Participant classification name: Name of this participant classification.

Participation registration permission flag: Flag which controls whether a visitor can register for participation by himself/herself. If possible, a participation registration process utilizing the QR code (or the registration code) is available.

Order possible item classification: A plurality of item classifications which can be ordered for the participant belonging to this participant classification can be selected.

According to this embodiment, it becomes possible to give a specific person drink or food via the Internet as described above.

### Other Embodiments

(Other Expected Cases)

The “Ogorare-kun” is described in the first embodiment as the one used in a club with live music, nightclub, event hall and the like. However, the “Ogorare-kun” can be implemented in combination with delivery service. Examples of the delivery service include a home-delivery pizza and the like. By installing the kitchen client (PC terminal), the receipt printer, the barcode reader and so on at a home-delivery pizzeria, the “Ogorare-kun” can be implemented by the same processing as that in the above-described embodiment. Similarly, the “Ogorare-kun” is applicable also to all commercial forms (mail order site, sushi shop, Japanese noodle shop, convenience store and so on) which offer delivery.

(Measure Against Mischief)

A function for a recipient side to be able to cancel an undesired gift may be provided.

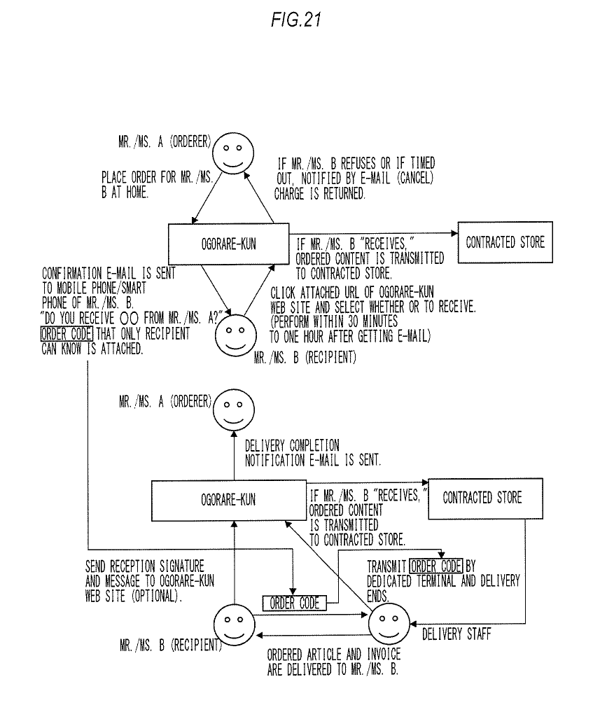

As for its method, the server device sends an e-mail to a recipient at the point in time when an order is placed, to cause the recipient to select whether to accept or refuse the gift. Further, the server device may cancel the order when the recipient does not select one within a predetermined time period (for example, within 30 minutes) after sending the e-mail. FIG. 21 is a view for explaining a measure against mischief. Note that the contracted stores are above-mentioned all commercial forms (mail order site, sushi shop, Japanese noodle shop, convenience store and so on) which offer delivery.

When providing an order screen for ordering a product which an orderer gives to a participant in the event to the PC or the like of the orderer and receiving an order through the order screen, the server device sends an e-mail including a URL of a site where whether or not to receive the ordered product is selectable and an order code to the mobile terminal device of the participant. Once the participant accesses the URL by the mobile terminal device and selects to receive the ordered product, the server device transmits the order to the PC or the like of the contacted store that is one example of the backyard terminal device in the backyard that provides the product.

After delivering the product to the participant (recipient) and getting the order code from the recipient, a delivery person inputs the order code into a carrying dedicated terminal. Then, the dedicated terminal transmits a notification of delivery completion including the order code (confirmation notification of confirmation of reception of the product) to the server device. Upon receiving the notification, the server device sends a notification e-mail via the Internet to the information processing device of the orderer who ordered the product.

(Tracking Location of a Participant Using Positional Information, and Valid/Invalid Control)

Many mobile phones and smart phones are equipped with a function capable of acquiring positional information such as GPS.

The server device may automatically recognize the location of the participant using the positional information, update the location of the participant registered in the Ogorare-kun, and control valid/invalid state.

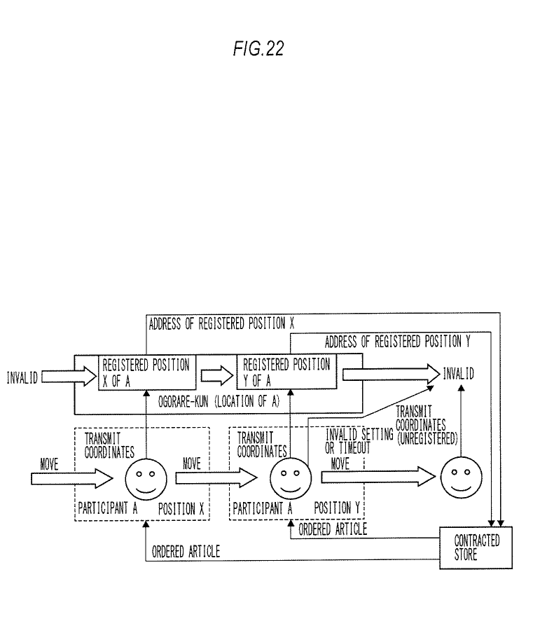

FIG. 22 is a view for explaining tracking of the location of the participant and valid/invalid control using the positional information. For example, the server device has the participant register a product reception position where the participant will receive the product, and stores it in a memory such as a hard disk or the like. Then, the server device enables the participant to receive the order at the point in time when the participant arrives at the position or within a predetermined distance (within a predetermined range) from the position.

Note that at return of the e-mail described for the aforementioned measure against mischief, the positional information may be attached thereto, so that the order is automatically refused in the case of coordinates without position registration. This makes it possible to prevent passage of the order to the contracted store in a delivery destination unknown state.

(Trigger Function Using Reservation and Positional Information, Date and Time and so on)

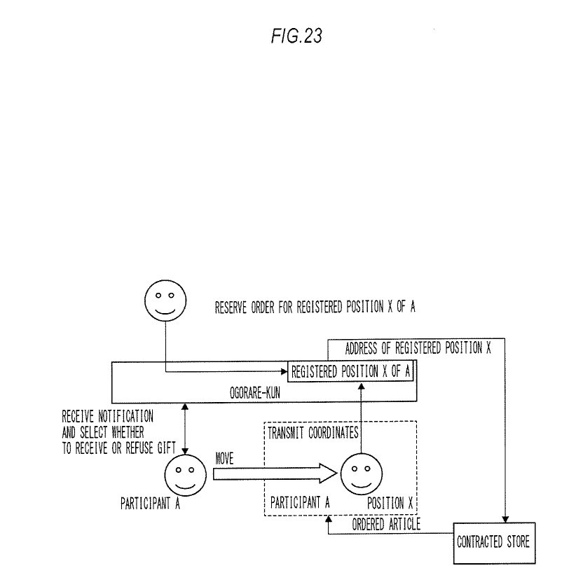

It may be enabled that the orderer reserves beforehand an order at a registration position, date and time and so on. FIG. 23 is a view for explaining a trigger function using reservation and the positional information. For example, the server device enables the orderer to reserve an order with respect to a position X that a participant A has registered. The server device then decides the order at the point in time when the participant A arrives within a predetermined distance from the position X, and transmits the order to the nearest contracted store. Note that as has been explained in the measurement against mischief, the server device may notify the recipient of the reservation beforehand and cause the recipient to select whether or not to receive the order.

(Return Gift Function)

Not only the participant but also the orderer side register individual information such as address, name and so on in the “Ogorare-kun,” whereby the orderer can receive a return order in a reverse direction from the participant who received a gift.

In short, this is synonymous with that the orderer also registers as a “participant” who receives a gift.

Note that the return gift function can be used at the following various timings.

A first one is a timing when the confirmation e-mail is sent to the participant whether to accept the gift or not. When accessing the WEB site of the “Ogorare-kun” for transmission of acceptance/refusal, the participant accesses a page where a return order is made.

A second one is a timing when the reception signature is put. When accessing the WEB site of the “Ogorare-kun” for transmission of his/her reception signature, the participant accesses the page where a return order is made.

As another timing, the participant can also place an order when accessing the WEB site of the “Ogorare-kun” afterward since the ID of the orderer is printed on the invoice.

(Cooperation with Existing WEB Services)

The “Ogorare-kun” is installed in SNS to make it possible to give or to be given in a connection of a community (among friends). Similarly, in the case of using SNS, the individual information does not need to be disclosed to the other side.

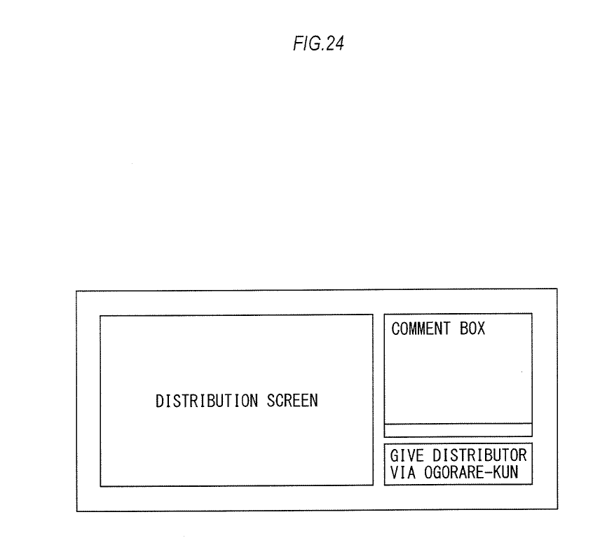

Further, it is possible to further promote the use of the “Ogorare-kun” by installation thereof in the streaming distribution site itself. FIG. 24 is a view illustrating an example in which a “give distributor” button is prepared beside a distribution screen.

Preferred embodiments of the present invention have been described in detail. However, the present invention is not limited to the specific embodiments but can be variously modified and changed within a scope of the present invention described in Claims.

Though the explanation is made for a case where the given object is a product such as food, drink or the like as an example in the above-described embodiments, this also applies to donation of service (labor), money, product and the like.

According to the above-described embodiments, a technique can be provided which makes it possible to give or donate an arbitrary product such as drink, food or the like or service to a specific person over the Internet.

Hereinafter, various aspects of the present invention will be described as additional notes.

(Addition 1) A gift system comprising a Web server device, a backyard terminal device in a backyard that provides a product which an orderer gives to a participant, and an information output device,

wherein said Web server device provides an order screen for ordering the product which the orderer gives to the participant to an information processing device of the orderer via the Internet, and transmits, upon receiving the order via the order screen, the order to said backyard terminal device in the backyard that provides the product,

wherein said backyard terminal device requests, upon receiving the order via said Web server device, said information output device to output information including a content of the order and identification information for identifying the participant to be given the product,

wherein said information output device outputs the information upon receiving the request, and

wherein said Web server device notifies, upon confirming reception of the product by the participant, the information processing device of the orderer who ordered the product of the reception via the Internet.

(Addition 2) The gift system according to (Addition 1),

wherein said backyard terminal device requests said information output device to output information including the content of the order and the identification information for identifying the participant to be given the product and a code for reception confirmation of the product, and

wherein when accessed from a mobile terminal device of the participant who has been given the product by reading the code for reception confirmation of the product included in the information, said Web server device confirms reception of the product and notifies the information processing device of the orderer who ordered the product of the reception via the Internet.

(Addition 3) The gift system according to (Addition 1), further comprising:

a terminal device operable by the participant who has been given the product,

wherein said Web server device confirms, upon receiving information indicating that a reception signature has been put from the participant via the terminal device, reception of the product and notifies the information processing device of the orderer who ordered the product of the reception via the Internet.

(Addition 4) The gift system according to (Addition 2),

wherein when accessed from a mobile terminal device by reading a code for participation registration posted at a venue of an event, said Web server device acquires an individual identification number of the mobile terminal device, provides a registration screen to the mobile terminal device, and registers participant information of a participant inputted via the registration screen and the individual identification number in association with each other in a storage device.

(Addition 5) The gift system according to (Addition 4),

wherein when accessed from the mobile terminal device of the participant who has been given the product by reading the code for reception confirmation of the product included in the information, said Web server device acquires the individual identification number of the mobile terminal device, acquires identification information for identifying a corresponding participant from the storage device on the basis of the individual identification number, and confirms, when the participant is the participant who has been given the product, reception of the product on the basis of the identification information and notifies the information processing device of the orderer who ordered the product of the reception.

(Addition 6) The gift system according to (Addition 4),

wherein when accessed from a mobile terminal device by reading a code for participation deregistration posted at the venue of the event, said Web server device acquires an individual identification number of the mobile terminal device, specifies corresponding participant information from the storage device on the basis of the individual identification number, and sets information indicating deregistration therein.

(Addition 7) A Web server device that provides an order screen for ordering a product which an orderer gives to a participant to an information processing device of the orderer via the Internet, transmits, upon receiving the order via the order screen, the order to a backyard terminal device in a backyard that provides the product, and notifies, upon confirming reception of the product by the participant, the information processing device of the orderer who ordered the product of the reception via the Internet.
(Addition 8) The Web server device according to (Addition 7),

wherein when accessed from a mobile terminal device of the participant who has been given the product by reading a code for reception confirmation of the product included in information including a content of the order and identification information for identifying the participant to be given the product and the code, said Web server device confirms reception of the product and notifies the information processing device of the orderer who ordered the product of the reception via the Internet.

(Addition 9) A Web server device that provides an order screen for ordering a product which an orderer gives to a participant to an information processing device of the orderer via the Internet, transmits, upon receiving the order via the order screen, a notification including a URL of a site where whether or not to receive the order is selectable and an order code to a mobile terminal device of the participant, transmits, when the URL is accessed from the mobile terminal device and reception of the order is selected, the order to a backyard terminal device in a backyard that provides the product, and notifies, upon receiving a confirmation notification of reception of the product by the participant including the order code from a terminal device carried by a delivery person who delivers the product, the information processing device of the orderer who ordered the product of the reception via the Internet.
(Addition 10) The Web server device according to (Addition 9),

wherein said Web server device acquires positional information on the participant from a positional information specifying function of the mobile terminal device and enables, when the acquired positional information falls within a predetermined range from a product reception position registered in a storage device, the order of the product for the participant on the order screen.

(Addition 11) A Web server device that provides an order screen for ordering a product which an orderer gives to a participant to an information processing device of the orderer via the Internet, transmits, upon receiving the order via the order screen, a notification including a URL of a site where whether or not to receive the order is selectable and an order code to a mobile terminal device of the participant, reserves the order when the URL is accessed from the mobile terminal device and reception of the order is selected, acquires positional information on the participant from a positional information specifying function of the mobile terminal device, decides the reserved order when the acquired positional information falls within a predetermined range from a product receipt position registered in a storage device, and transmits the order to a backyard terminal device in a backyard that provides the product.
(Addition 12) An information processing method in a gift system comprising a Web server device, a backyard terminal device in a backyard that provides a product which an orderer gives to a participant, and an information output device, said information processing method comprising:

a first step of the Web server device providing an order screen for ordering the product which the orderer gives to the participant to an information processing device of the orderer via the Internet;

a second step of the Web server device transmitting, upon receiving the order via the order screen, the order to the backyard terminal device in the backyard that provides the product;

a third step of the backyard terminal device requesting, upon receiving the order via the Web server device, the information output device to output information including a content of the order and identification information for identifying the participant to be given the product;

a fourth step of the information output device outputting the information upon receiving the request; and

a fifth step of the Web server device notifying, upon confirming reception of the product by the participant, the information processing device of the orderer who ordered the product of the reception via the Internet.

(Addition 13) The information processing method according to (Addition 12),

wherein in said third step, the backyard terminal device requests the information output device to output information including the content of the order and the identification information for identifying the participant to be given the product and a code for reception confirmation of the product,

wherein in said fourth step, the information output device outputs the information upon receiving the request, and

wherein in said fifth step, when accessed from a mobile terminal device of the participant who has been given the product by reading the code for reception confirmation of the product included in the information, the Web server device confirms reception of the product and notifies the information processing device of the orderer who ordered the product of the reception via the Internet.

(Addition 14) An information processing method executed by a Web server device, comprising:

providing an order screen for ordering a product which an orderer gives to a participant to an information processing device of the orderer via the Internet;

transmitting, upon receiving the order via the order screen, the order to a backyard terminal device in a backyard that provides the product; and

notifying, upon confirming reception of the product by the participant, the information processing device of the orderer who ordered the product of the reception via the Internet.

(Addition 15) The information processing method according to (Addition 14),

wherein in said step of notifying, when accessed from a mobile terminal device of the participant who has been given the product by reading a code for reception confirmation of the product included in information including a content of the order and identification information for identifying the participant to be given the product and the code, reception of the product is confirmed and the information processing device of the orderer who ordered the product is notified of the reception via the Internet.

(Addition 16) An information processing method executed by a Web server, comprising:

providing an order screen for ordering a product which an orderer gives to a participant to an information processing device of the orderer via the Internet;

transmitting, upon receiving the order via the order screen, a notification including a URL of a site where whether or not to receive the order is selectable and an order code to a mobile terminal device of the participant,

transmitting, when the URL is accessed from the mobile terminal device and reception of the order is selected, the order to a backyard terminal device in a backyard that provides the product; and

notifying, upon receiving a confirmation notification of reception of the product by the participant including the order code from a terminal device carried by a delivery person who delivers the product, the information processing device of the orderer who ordered the product of the reception via the Internet.

(Addition 17) A gift system comprising a Web server device, a backyard terminal device in a backyard that provides service which an orderer gives to a participant, and an information output device,

wherein said Web server device provides an order screen for ordering the service which the orderer gives to the participant to an information processing device of the orderer via the Internet, and transmits, upon receiving the order via the order screen, the order to said backyard terminal device in the backyard that provides the service,

wherein said backyard terminal device requests, upon receiving the order via said Web server device, said information output device to output information including a content of the order and identification information for identifying the participant to be given the service,

wherein said information output device outputs the information upon receiving the request, and

wherein said Web server device notifies, upon confirming reception of provision of the service by the participant, the information processing device of the orderer who ordered the service of the reception via the Internet.

(Addition 18) A program product for causing a computer to execute:

providing an order screen for ordering a product which an orderer gives to a participant to an information processing device of the orderer via the Internet;

transmitting, upon receiving the order via the order screen, the order to a backyard terminal device in a backyard that provides the product; and

notifying, upon confirming reception of the product by the participant, the information processing device of the orderer who ordered the product of the reception via the Internet.

(Addition 19) A program product for causing a computer to execute:

providing an order screen for ordering a product which an orderer gives to a participant to an information processing device of the orderer via the Internet;

transmitting, upon receiving the order via the order screen, a notification including a URL of a site where whether or not to receive the order is selectable and an order code to a mobile terminal device of the participant,

transmitting, when the URL is accessed from the mobile terminal device and reception of the order is selected, the order to a backyard terminal device in a backyard that provides the product; and

notifying, upon receiving a confirmation notification of reception of the product by the participant including the order code from a terminal device carried by a delivery person who delivers the product, the information processing device of the orderer who ordered the product of the reception via the Internet.

### INDUSTRIAL APPLICABILITY

The present invention is applicable to a technique of giving or donating an arbitrary product such as drink, food or the like or service to a specific person over the Internet.

1. A gift system comprising a Web server device, a backyard terminal device in a backyard that provides a product which an orderer gives to a participant, and an information output device,
wherein said Web server device provides an order screen for ordering the product which the orderer gives to the participant to an information processing device of the orderer via the Internet, and transmits, upon receiving the order via the order screen, the order to said backyard terminal device in the backyard that provides the product,
wherein said backyard terminal device requests, upon receiving the order via said Web server device, said information output device to output information including a content of the order and identification information for identifying the participant to be given the product,
wherein said information output device outputs the information upon receiving the request, and
wherein said Web server device notifies, upon confirming reception of the product by the participant, the information processing device of the orderer who ordered the product of the reception via the Internet.

2. The gift system according to claim 1,
wherein said backyard terminal device requests said information output device to output information including the content of the order and the identification information for identifying the participant to be given the product and a code for reception confirmation of the product, and
wherein when accessed from a mobile terminal device of the participant who has been given the product by reading the code for reception confirmation of the product included in the information, said Web server device confirms reception of the product and notifies the information processing device of the orderer who ordered the product of the reception via the Internet.

3. The gift system according to claim 1, further comprising:
a terminal device operable by the participant who has been given the product,
wherein said Web server device confirms, upon receiving information indicating that a reception signature has been put from the participant via the terminal device, reception of the product and notifies the information processing device of the orderer who ordered the product of the reception via the Internet.

4. The gift system according to claim 2,
wherein when accessed from a mobile terminal device by reading a code for participation registration posted at a venue of an event, said Web server device acquires an individual identification number of the mobile terminal device, provides a registration screen to the mobile terminal device, and registers participant information of a participant inputted via the registration screen and the individual identification number in association with each other in a storage device.

5. The gift system according to claim 4,
wherein when accessed from the mobile terminal device of the participant who has been given the product by reading the code for reception confirmation of the product included in the information, said Web server device acquires the individual identification number of the mobile terminal device, acquires identification information for identifying a corresponding participant from the storage device on the basis of the individual identification number, and confirms, when the participant is the participant who has been given the product, reception of the product on the basis of the identification information and notifies the information processing device of the orderer who ordered the product of the reception.

6. The gift system according to claim 4,
wherein when accessed from a mobile terminal device by reading a code for participation deregistration posted at the venue of the event, said Web server device acquires an individual identification number of the mobile terminal device, specifies corresponding participant information from the storage device on the basis of the individual identification number, and sets information indicating deregistration therein.

7. A Web server device that provides an order screen for ordering a product which an orderer gives to a participant to an information processing device of the orderer via the Internet, transmits, upon receiving the order via the order screen, a notification including a URL of a site where whether or not to receive the order is selectable and an order code to a mobile terminal device of the participant, transmits, when the URL is accessed from the mobile terminal device and reception of the order is selected, the order to a backyard terminal device in a backyard that provides the product, and notifies, upon receiving a confirmation notification of reception of the product by the participant including the order code from a terminal device carried by a delivery person who delivers the product, the information processing device of the orderer who ordered the product of the reception via the Internet.

8. The Web server device according to claim 7,
wherein said Web server device acquires positional information on the participant from a positional information specifying function of the mobile terminal device and enables, when the acquired positional information falls within a predetermined range from a product reception position registered in a storage device, the order of the product for the participant on the order screen.

9. A Web server device that provides an order screen for ordering a product which an orderer gives to a participant to an information processing device of the orderer via the Internet, transmits, upon receiving the order via the order screen, a notification including a URL of a site where whether or not to receive the order is selectable and an order code to a mobile terminal device of the participant, reserves the order when the URL is accessed from the mobile terminal device and reception of the order is selected, acquires positional information on the participant from a positional information specifying function of the mobile terminal device, decides the reserved order when the acquired positional information falls within a predetermined range from a product receipt position registered in a storage device, and transmits the order to a backyard terminal device in a backyard that provides the product.
